(19) United States
(12) Patent Application Publication
(10) Pub. No.: US 2009/0327370 A1
(43) Pub. Date: Dec. 31, 2009

(54) DEFRAGMENTATION OF DIGITAL STORAGE MEDIA

(75) Inventor: Carsten Schmidt, Hadsten (DK)

Correspondence Address: CANTOR COLBURN, LLP, 20 Church Street, 22nd Floor, Hartford, CT, 06103, US

(73) Assignee: Warp Disk Software V/Carsten Schmidt, Hadsten (DK)

(21) Appl. No.: 12/374,765

(22) PCT Filed: Jul. 20, 2007
(86) PCT No.: PCT/DK2007/000365

§ 371 Date: Jan. 22, 2009

(30) Foreign Application Priority Data
Jul. 22, 2006 (DK) PA 2006 01008

(51) Int. Cl. G06F 12/02; G06F 3/06; G06F 17/30

(52) U.S. Cl. 707/205; 707/E17.01

(57) ABSTRACT

The invention concerns a technique for defragmenting digital storage media (disks). The invention is based on a filter driver or corresponding technology receiving all I/O to and/or from the file system driver, and which by itself is able to send I/O requests to the file system driver FIG. 2 illustrates the basic architecture of the invention in the form of a data flow diagram. Filter (201) receives all I/O requests to and/or from the underlying file system driver. I/O-Synchronizer (202) controls when defragmentation can be performed without interfering with external I/O requests. In Defragmenter (203) is running a separate thread that analyzes files for fragmentation received from Filter (201). Fragmented files are defragmented by sending I/O requests to the file system driver, but only when I/O-Synchronisator (202) allows it. Thereby it is immediately recognised when a files has been fragmented, and it may be defragmented momentarily without affecting in any appreciable way the remaining yield of the system.

### FIELD OF THE INVENTION

The present invention concerns a system for defragmenting digital storage media, where the system consists of a computer containing one or more digital storage media (disks), the storage space of which being divided into sectors each constituting a fragment of file data, where a filter driver or corresponding technology receiving all I/O to and/or from the file system driver at time intervals performs a defragmentation whereby the sectors of the individual files are moved so that each file will occupy a continuous array of sectors.

### BACKGROUND OF THE INVENTION

By convention, the storage space on digital storage media (disks) is divided into a number of fixed data volumes called sectors, each typically of 512 bytes. A single reading or recording operation on a disks always covers a whole sector. A disk is divided into one or more independent partitionings. A partitioning table on the disk stores the start sector, size etc. of each partitioning. A volume is a logical representation of one or more partitionings on one or more disks that file system drivers recognise as a single unit. A file system driver does not communicate directly with the disks but rather go through the individual volumes. The file system is thereby made independent of the properties of the physical disks.

Before the file can be written to a volume, it is to be formatted with a file system. The formatting creates an allocation table on the volume which the file system uses for organising and localising files. Each single volume is formatted by its own file system.

When a volume has newly been formatted with a file system, there is space for storing the sectors of a file in continuous form in one place. This allows rapid sequential reading and recording of files. However, as files are added, deleted and change size, the volume becomes fragmented so that there are only small holes of available sectors in which data may to be disposed. When a new file is to be created, or an existing file is enlarged, the new sectors are spread around in the volume. Thereby the speed whereby whereby files may be read and recorded is reduced due the extra search time to be used when the disk is to move its reading/recording head.

Defragmentation is to reallocate the fragmented sectors in a volume so that each file will occupy a continuous sequence of sectors. A large number of patents discussing defragmentation of disks have been registered. Often a defragmentation application accompanies the operating system. Besides, there are some commercial applications on the market for defragmenting disks. Common to all is that they run in user state.

In order to prevent user applications from accessing and/or modifying critical operating system data, most operating systems use two or more CPU states: user state and core state. Programme code in user applications executes in user state, while operating system code (as system services and drivers) executes in core state. User state refers to an execution state in the CPU where individual processors cannot access memory or programme code in other processes and do not have access to all CPU instructions. Core state refers to an execution state in the CPU giving access to all system memory and all CPU instructions. By giving the operating system software greater privileges than the application software, the CPU provides the operating system with a necessary foundation in order to ensure that malicious or badly programmed application do not destroy the stability of the system. At the same time, the operating system may control and check which informations users and applications may access. The part of the operating system running in core state is called the core.

Each process in user state only has access to its own private memory, while operating system and driver code in core state has access to all memory. In other words, the operating system and the drivers have full access to the system memory and may bypass safety mechanisms when objects that normally are protected are to be accessed. In fact, this vulnerability was one of the causes for introducing driver signature in Microsoft Windows 2000 warning the user if installation of unauthorised (unsigned) driver is attempted installed.

A unit driver is a piece of software monitoring and controlling a certain unit. Such a unit may e.g. be a file system or a harddisk. Another kind of driver is a filter driver. A filter driver is a driver that overlays a unit driver and receives all I/O requests to and responses from the unit driver. It copies, so as to say, the interface of the filtered unit driver. Since it overlays another driver, it may log, observe, modify, prevent or delay I/O requests to and responses from the underlying driver. It may also make quite new I/O requests to drivers on its own initiative. The filter drivers most used are file system filter drivers, as used e.g. by anti-virus programs and encryption programs.

FIG. 1 shows a simplified overview of how an I/O request, e.g. “ReadFile”, travels from a user application (101) to the disk (108) and back on a system with a file system filter driver (104) installed. At first, the user application (101) makes a call to the user sub-system (102) which is part of the operating system running in user state. The purpose of the user sub-system is to make an API (Application Program Interface) available for user applications. The user sub-system performs a special CPU instruction that makes the CPU shift to core state. The I/O request has now reached the core sub-system (103) which consists of a number of operating system services. At a point in time before the request reaches the filter driver (104), it has been verified that the user application has the required rights. The request continues down through the file system driver (105), the volume driver (106) and disk driver (107) where each prepares and sends an I/O request to the succeeding driver. At last, the requested sectors are read from the disk (108) after which the reply follows the chain upwards back to the user application. However, the call does not necessarily reach right down to the disk. Anywhere in the chain, requested data may e.g. be cached, or a driver may use lazy-writes that hold recordings back for a period of time. The call may also start anywhere in the chain. It does not have to be initiated by a user application. The entire execution from the user application (101) to the disk (108) and back will usually execute in the thread of the user application. In other words, drivers do not have their own thread but operate in an arbitrary thread.

Typically, drivers do not call each other directly. Instead, they send I/O requests to each other via an I/O manager which is responsible for organising all I/O. By letting an I/O manager be an intermediary link it follows that the individual drivers are independent of independent of each other so they can be loaded and unloaded without any significance to other drivers. This also implies that filter drivers are in reality invisible to other drivers.

When a volume is coupled to the system, a file system driver is to take ownership of it before its files may be accessed. At first, a volume driver is created. It is then up to the I/O manager to find out which file system driver to be associated with it. On Microsoft Windows 2000, each file system driver is in turns called with a mount request until one of them recognises the file system on the volume, after which the file system driver is associated with the volume. It is possible for a file system filter driver to receive this mount-request and to work on the volume through the volume driver before the mount-request is transmitted to the 25 file system driver. In the same way, a file system filter driver receives a dismount request and may work on the volume through the volume driver after the file system driver has executed the dismount-request.

The described operating system structure and the listing of system components is based on the architecture in Microsoft Windows 2000, XP and 2003, but most other modem operating systems as Linux, UNIX and Mac OS function in the same way in principle. Filter drivers is a term used in Microsoft Windows, but the technique is also known from other operating systems. It is different from operating system to operating system how filter drivers are realised, and they may have other names. For example, similar features may be achieved by means of LSM (Linux Security Modules) framework in Linux.

A defragmenting application runs in user state and may only defragment a file by interacting with the user sub-system. Typically, this is effected in that the file is opened at first, and then a number of “MoveFile” commands are executed, after which the file is closed again. Al things considered, this method is an unfavourable technical solution:

Firstly, a file is to be opened before it can be defragmented. If the file is locked by another process, or the application does not have the required rights, it cannot be opened and not defragmented either. Even with superuser rights it is normally not possible to open locked files.

Secondly, it is only discovered that a file has been fragmented when the user is running his defragmentation application. In other words, files may be fragmented for a long time if the user is not in the habit of running his defragmentation application regularly. Files that are often in use may be strongly fragmented without the knowledge of the user.

Thirdly, it is required that the user starts his defragmentation application by himself if the user desires to defragment his disk. Many users are not paying attention to defragment regularly, or they are also not even aware of the problem. Other users are reluctant as they do not want the defragmenting application to take resources from other running applications. The problem is normally solved by letting the defragmenting application run at certain times where the system is not occupied by other tasks, e.g. every night. This is also inconvenient because it forces the user to let his computer be switched on all night.

Fourthly, defragmentation applications dull other running applications. This is not only due to the fact that they have to share the CPU time with other applications. This is particularly due to the fact that they have to share the disk with other applications. When a file is defragmented, the disk is occupied, and other applications may neither read nor record to the disk in the meantime. It does not help much to give the defragmentation application low CPU priority. If an application sends an I/O request to a disk, its thread goes into a wait state until the I/O request has been executed, unless it has other things to do. If there are no other threads waiting to get CPU time, the defragmentation application is allowed to get on, even if its thread is running with the lowest possible CPU priority. Its I/O requests will thus interfere with other I/O requests, irrespectively of the CPU priority. In other words, a defragmentation application will always compete with other programs about getting its I/O requests through. The problem is only worsened if the system has several CPUs, or the CPU has several cores.

Attempts have been made to solve the mentioned technical problems in defragmentation. For example, the patent US 2004/0013008 A1 indicates a technique incorporating defragmentation in the file system itself. When a file is opened for reading, the file system examines the file system whether the file is fragmented. If that is the case, the entire content is read into a buffer in the memory. Then the file is read from the buffer instead of from the disk. At the same time, the file is defragmented in the background. The user will thus not experience any delay, even if the file is defragmented in the background. However, the user has to wait for the buffer in the memory to be filled when the file is opened. When the file is closed or there is recorded to it, the defragmentation is interrupted. Thereby, a fragmented file is only defragmented if the file system can get it defragmented in time before it is closed or is recorded in. In small apparatuses with open files which are read over long time, as e.g. MP3 players or the like, the invention may probably be very useful. In its first claim, the patent also specifies that the invention is intended for that type of apparatuses: “A recording and reproducing apparatus for recording and reproducing a video signal or an audio signal . . . ”. However, the technique does not solve the problem that simultaneous processes accessing the disk during defragmentation experience delays in their I/O requests. The invention will probably not be of any great use in large operating systems with many simultaneous processes having many files open at a time which are read as quickly as possible. Here, Microsoft Windows, Mac OS, Linux, UNIX and similar operating systems are particularly BORNE in mind.

Another patent, US 2006/0149899 A1, describes a similar method where fragmented files are defragmented in connection with I/O requests. When the file system receives an I/O request on a file, the file system examines first if the file is fragmented. If that is the case, the file is defragmented, whereafter the I/O request is executed as normally. The method causes delay of the initial I/O request and the same problem with parallel I/O requests. The parallel I/O requests will also experience longer execution time due to the simultaneous defragmentation.

This invention describes a technique not only having the same advantages as the patents US 2004/0013008 A1 and US 2006/0149899 A1 but which also solve their disadvantages, as the defragmentation does not delay the execution time for parallel I/O I/O requests that are performed simultaneously with the defragmentation. One element in the invention is just that the defragmentation only takes place when both the CPU and the disk are inactive. The similarity between this invention and the patents US 2004/0013008 and US 2006/0149899 A1 is primarily that I/O to the file system driver entails that fragmented files are discovered, and that they are defragmented without any interaction from the user, but the method is not quite the same. The same similarity may also be pointed out between patent US 2006/0149899 A1 and patent US 2004/0013008 A1 which, despite their similarities, have appeared both to be patentable. In fact, these patents overlap each other in their idea much more than the present invention does in relation to any of the said patents.

There is already a defragmentation application on the market trying only to defragment when the disk activity is low. A commercial product called “Diskkeeper” tries to solve this problem by using a technology called “I/O Smart” by the firm behind it (Executive Software). According to the information from Executive Software itself, this should imply an imperceptible defragmentation. However, this is a truth with some modification. A product called “Iometer” is an analysing tool that can measure the output on storage medias. An Iometer-test consisting of 2 kB random I/O with a mix of 67% reading and 33% recording, representing a typical work load for a data base, an average about 75% of the normal number of I/O requests were allowed if Diskeeper was defragmenting simultaneously with the test. This result was measured with Iometer version 2004.07.30 and Diskeeper Professional version 9.0.504.0. This invention concerns a technique which, besides discovering fragmentation of the disk as it appears and defragments without any interaction from the user, it only performs defragmentation in one and the same invention when the disk is inactive. A prototype of this invention has shown that the invention may defragment without “Iometer” is able to indicate a measurable drop in the number of I/O requests.

The patent EP 1225509 A2 describes how filter drivers may be organised according to function so that several successive filter drivers are arranged in a deterministic sequence. The only relevance in connection with the patent application is that they both involve filter drivers. Neither this patent nor the patent application tries to patent the use of file system filter drivers for performing monitoring and file control tasks.

### OBJECT OF THE INVENTION

It is the purpose of the invention to recognise fragmentation of files as the fragmentation arises, whereby defragmentation may be completely avoided. A further purpose of the invention is to enable all files to be defragmented irrespectively of rights and locking.

### DESCRIPTION OF THE INVENTION

The purpose may be achieved with a system as described in the introduction, if a component in the filter driver sends a signal when I/O requests are received that will cause disk-I/O (204) and/or have caused disk-I/O, and additionally sends a signal when receiving of I/O requests that will change the physical position of a file on the disk and/or have changed the physical position of a file on the disk, where the signals are received by a component in the filter driver which on the basis of the signals analyses and sends a signal when I/O can be performed on the disk without interfering with external I/O requests and when it cannot be performed.

The invention is based on a filter driver or corresponding technology receiving all I/O to and/or from the file system driver, and which by itself is able to send I/O requests to the file system driver. If the filter driver receives an I/O request of a type which may cause or has caused fragmentation of a file, this is intercepted and registered by the filter driver. Registered fragmented files are later defragmented in core state via the filter driver when both the CPU and the disk are available. On the basis of the intercepted I/O requests the system analyses and controls when the defragmentation may take place without interfering with I/O requests originating externally. The disk defragmentation may hereby be performed without interfering with or delaying other activities in the computer.

In parallel with the filter driver, a component in the filter driver analyses files received through the signals for fragmentation and defragmentation of fragmented files. On the basis of the signals, the component only provides for sending I/O requests to the file system driver when this may be done without interfering with external I/O requests.

If the filter driver intercepts volume mount and/or dismount requests to and/or from the file system driver, fragmented files may be defragmented by sending I/O requests directly to the volume driver at a time when the file system driver is not associated with the volume driver. System files which normally cannot be defragmented may thus be defragmented as the file system does not have possibility of locking the access to the system files at this time.

If the filter driver receives an I/O request that will make a file grow, and there is not a sufficient number of available adjacent sectors, causing fragmentation, then the adjacent sectors may be released by moving them to another point in the volume before the I/O request is transmitted to the file system driver. System files that normally cannot be defragmented may thus be kept defragmented in a running system as the file system will find that the adjacent sectors are available and fragmentation is avoided.

FIG. 2 illustrates the basic architecture of the invention in the form of a data flow diagram. The broken lines in the Figure are signals. These are the messages which the components of the invention are transmitting to each other. A signal is also called an event as seen by the receiver of the signal. When a component receives a signal (event) which it is listening for, this will cause some kind of reaction on the part of the receiver.

The invention consists of three components: Filter (201), I/O-Synchronisator (202) and Defragmenter (203).

Filter (201) receives all I/O requests to and/or from the underlying file system driver (105). If an I/O request is received that will cause disk I/O, a Disk-I/O-starting event (204) is transmitted. If an I/O request is received from the file system driver having caused disk I/O, a Disk-I/O-final event (205) is transmitted. In the same way, I/O requests that will change or have changed the physical position of a file on the disk and thus may have caused fragmentation result in Reallocating(file) (206) and Reallocated(file) signals (207). A mount request causes mounting (208) and mounted signals (209), and a dismount causes dismounting and (210) and Dismounted signals (211).

I/O-Synchronisator (202) keeps track on when the disk is in use and when it is available. If the disk is available, defragmentation can be performed without interfering with external I/O requests. I/O-Synchronisator (202) receives all Disk-I/O-start-(204) og Disk-I/O-end events (205), and therefor it knows precisely when the disk is active and in which pattern it is active. Thereby it may analyse when Defragmenter (203) may be allowed to transmit I/O requests (defragmenting) without interfering with external I/O requests. If allowed, an Allow-I/O-signal (212) is sent. If not allowed, a Prohibit-I/O-signal (213) is sent.

Defragmenter (203) operates in parallel with Filter (201) in one ore more separate threads. Its task is two-part. On the one hand, it is to analyse files for fragmentation which have been received through Reallocating(file)-events (206) and Reallocated(file)-events (207). On the other hand it is to defragment fragmented files by sending I/O requests to the file system driver (105), but only when I/O-Synchronisator (202) has accepted via Allow-I/O-signals (212) and Prohibit-I/O-signals (213). Alternatively, Defragmenter (203) immediately performs the analysis and the defragmentation when it receives a Reallocated(file)-signal (207) in the same thread as the one the event is transmitted in. Thus there is no need for a separate thread and I/O-Synchronisator (202) may be omitted. On the other hand, fragmented files are instantly defragmented and not only when the disk is available. In connection with a Mount-event (208) or Dismounted-event (211), Defragmenter (203) is able to defragment system files that normally cannot be defragmented by sending I/O requests directly to the volume driver in the same thread as the mount- or dismount-request is executed in. The preparatory work can be done during the lates dismount-event (210) where system files to be defragmented when the file system driver is not associated with the volume driver can be registered in a backlog.

As described below, by the invention one may relieve the technical problems connected with the present way of defragmenting a disk.

The invention may defragment all files. Irrespective of rights and locking. Since a filter driver does not operate in core state, it is usually not limited by safety mechanisms preventing access to files or libraries. The only obstacle may be the file system driver system driver (105) itself which a filter driver necessarily may go through if it desires to operate at a file level. System files controlled and protected by the file system driver (105) cannot be defragmented in a normal way. These files may, however, be defragmented in connection with a Mount-event (208) or Dismounted-event (211). Defragmenter (203) may move around with the volume sectors and by itself update the allocation table of the file system by communicating directly with the volume driver before the mount request is transmitted to the file system driver or after the dismount request has been executed by the file system driver. Another method is to prevent that system files become fragmented at any time. If Filter (201) receives an I/O request that will make a system file grow, and the subsequent sectors are in use already, normally entailing that the system file will be defragmented, Filter (201) may move the file located immediately after the system file before it transmits the I/O request. Thereby space is created and the system file will never be fragmented. However under the assumption that the file system driver will not fragment a system file if there is enough space to keep the sectors of the file sectors together.

The invention discovers immediately when a file has been fragmented at once and may begin defragmentation immediately. Since all I/O requests go through Filter (201), all I/O requests that may cause fragmentation are intercepted. It may e.g. occur when the file is created or when it grows. Defragmenter (203) may initiate defragmentation as soon as there are resources available for that purpose.

The invention renders superfluous a current defragmentation application which the user has to remember to run at regular intervals. Filter (201) is permanently situated over the file system driver (105), where it sends signals to I/O-Synchronisator (202) and Defragmenter (203). All these components may operate in the background.

The invention may defragment files without it having any appreciable influence on the remaining output of the system. Defragmenter (203) only defragments when I/O-Synkronisator (202) has registrered that the disk is available. If its thread(s) is running with the lowest possible CPU-priority, fragmentation will only take place when both the CPU and the disk are available. The invention may thereby perform imperceptible defragmentation. If I/O-Synchronisator (202) receives a Disk-I/O-start event (204) simultaneously while Defragmenter (203) is defragmenting, the extraneous I/O-forespørgsel may, however, experience a certain delay. Therefore it is important that Defragmenter (203) may rapidly interrupt its operations, e.g. by only moving a few sectors at a time.

### DESCRIPTION OF THE DRAWING

FIG. 1 shows how an I/O request travels from a user application (101) to the disk (108) and back on a system having installed a file system filter driver (104).

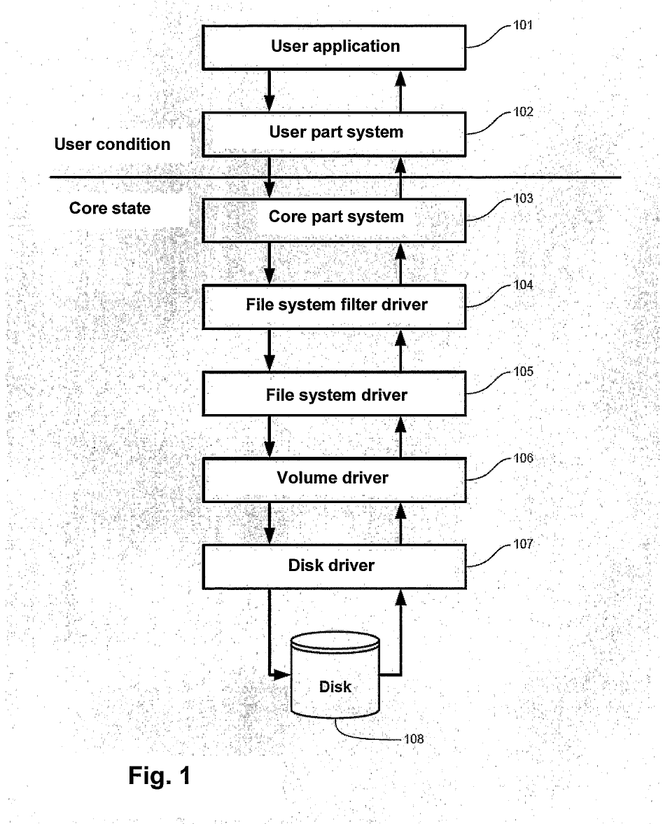

FIG. 2 illustrates the basic architecture of the invention in the form of a data flow diagram. The invention consists of three components: Filter (201), I/O-Synchronisator (202) and Defragmenter (203).

FIG. 3 is an example of the behaviour of a Filter component (201) filtering I/O requests to the filter driver (105).

FIG. 4 is an example of the behaviour of an I/O-Synchronisator (202) reacting to Disk-I/O-events (204).

FIG. 5 is an example of the behaviour of a Defragmenter thread (203) that only operates in co-operation with I/O Synchronisator (202) when the disk is available.

FIG. 6 is an example of a Defragmenter (203) registering unmovable files that could not be defragmented.

FIG. 7 is an example of a Defragmenter (203) hiding unmovable files in a backlog in connection with a dismounting event (208).

FIG. 8 is an example of defragmentation of unmovable files in connection with a mounting event (208).

FIG. 9 is an extension of FIG. 3 where system files are prevented from being defragmented by always providing for space for them to grow.

### DETAILED DESCRIPTION OF THE INVENTION

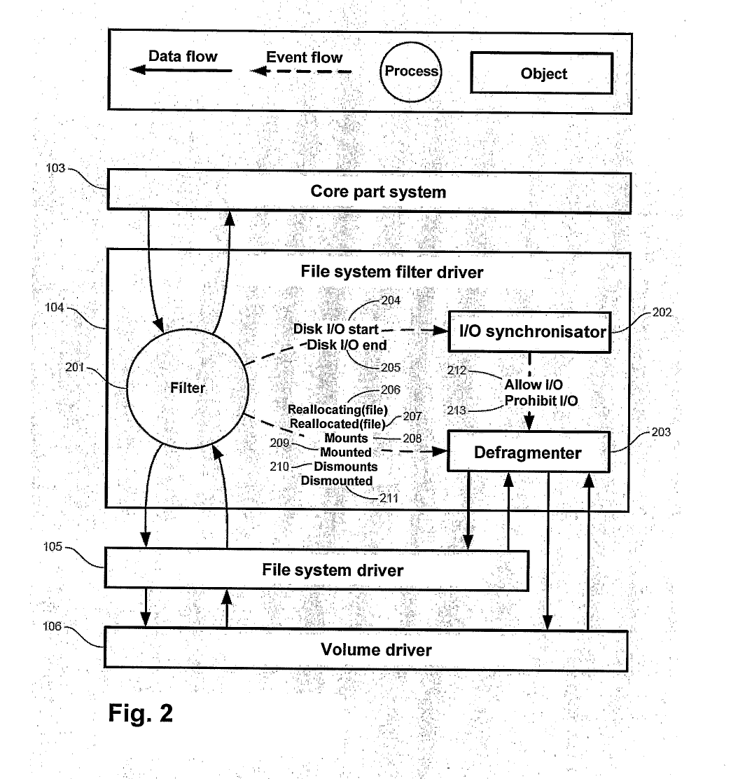

Several Figures are interconnected by signals/events that signal an event in the surroundings. All signals may be seen in FIG. 2 in the form of broken lines. As mentioned, signals are messages which the components of the invention are transmitting to each other. When a component receives a signal (event) which it is listening for, this will cause some kind of reaction on the part of the receiver.

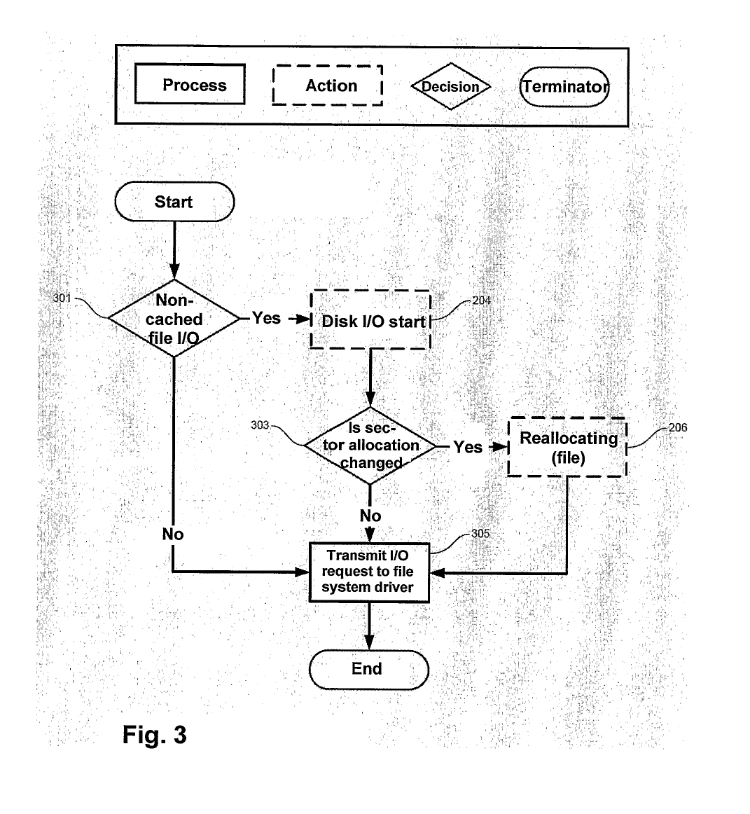

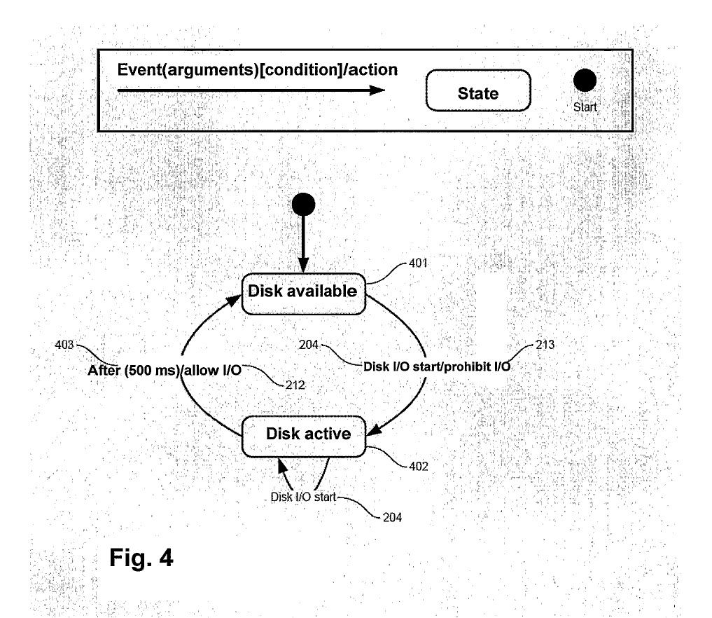

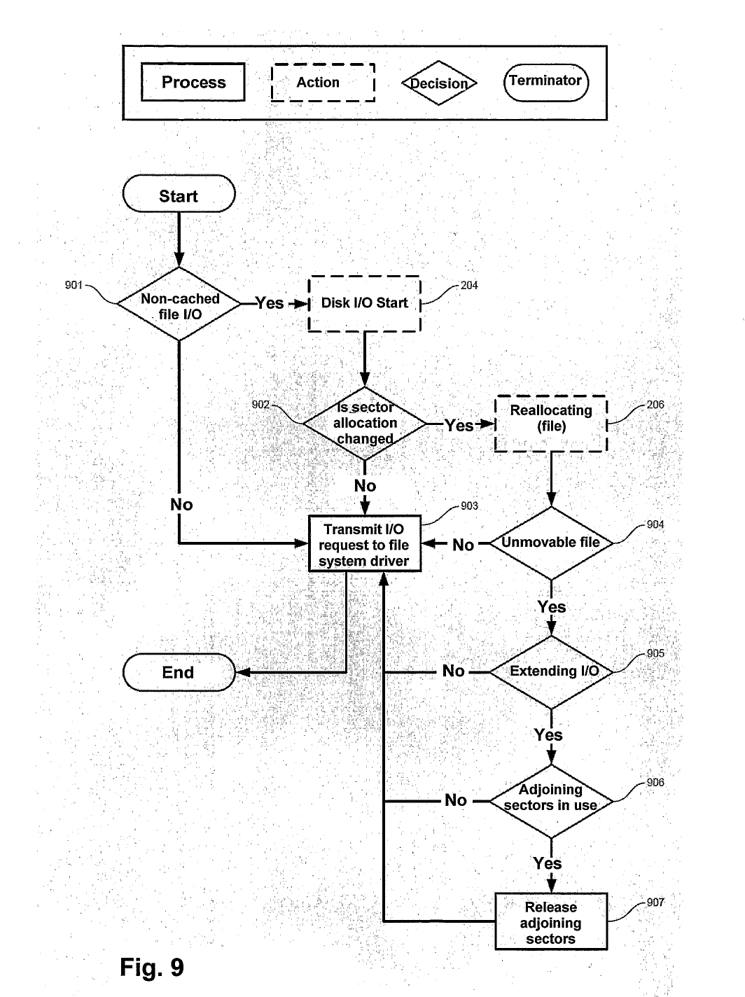

The signal Disk-I/O-start (204) is e.g. to be found both in FIGS. 2, 3, 4 and 9. FIG. 2 shows that Filter (201) sends Disk-I/O-start-signals (204) and that I/O-Synchronisator (202) listens for Disk-I/O-start-events (204). FIG. 3 and FIG. 9 are examples of when Filter (201) may send the signal. FIG. 4 is an example of how I/O-Synchronisator (202) may react to Disk-I/O-events (204), depending on which state the component is in.

Besides, the Figures operate with processes, objects and states. A process does not have a state, but is only transforming input to output. An object has behaviour as well as state.

### Examples of Embodiments

In the following, examples of possible realisations of the invention are given.

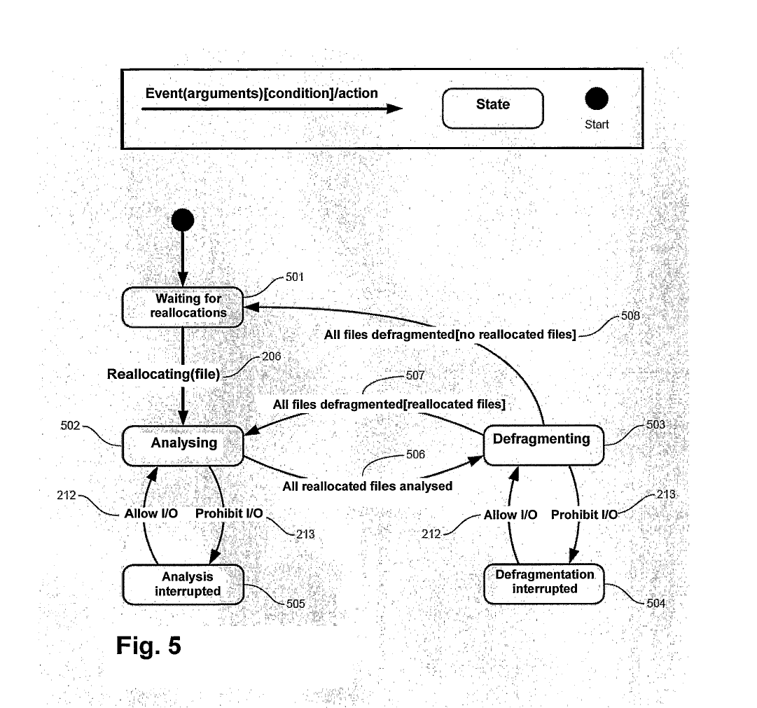

The first example demonstrates how files that are fragmented in a running system may be defragmented in the background without slowing running processes. The example does not include defragmentation of system files. It has its origin in the architecture shown in FIG. 2. It demonstrates a possible behaviour of the three primary components of the invention: Filter (201), I/O-Synchronisator (202) and Defragmenter (203). FIG. 3 shows behaviour of Filter (201) in a flowchart, FIG. 4 the behaviour of I/O-Synkronisator (202) in a state diagram, and FIG. 5 the behaviour of Defragmenter (203) in a state diagram.

FIG. 3 is an example of an algorithm for filtering I/O requests from the core part system (103) to the filter system driver (105) in Filter (201). The flowchart is completed from start to end for each filtered I/O request to the file system driver (105). Only non-cached-file-I/O (301) is relevant as cache operations do not result in disk-I/O. If the I/O I/O. If the I/O request is about a non-cached-file-I/O, a Disk-I/O-start event (204) is signalled, or else it is transmitted on to the file system driver (305). It is then examined if the request will change the sector allocation (303) of the file. This may e.g. be the case if it will get the file to grow in size. If that is the case, a Reallocation(file)-event (206) is signalled. Finally, the I/O request is transmitted unchanged to the file system driver (305).

FIG. 4 shows an example of a possible behaviour of I/O-Synchronisator (202). The state diagram starts in the state Disk-available (401). In this state the disk is available so that defragmentation can be performed without interfering with external I/O requests. As soon as a Disk-I/O-start-event (204) arises (signalled by the Filter-component (201)), a Prohibit-I/O-signal (213) is sent, and the state is changed to Disk-active (402), indicating that defragmentation cannot be performed without interfering with external I/O requests. As soon as I/O-Synchronisator (202) is in this state, Disk-I/O-start events (204) do not cause change of state. If a Disk-I/O-start event (204) has not been detected for 500 ms (403), an Allow-I/O-signal (212) is sent, and a change to state “Disk-available” (401) is made again. Changing from Disk-active (402) to Disk-available (401) after precisely 500 ms (403) is an arbitrary choice, however, it should minimum be the maximum time that an I/O request sent from a user application is expected to tak, and rather a number of ms more, as a process will often transmit several I/O requests in succession.

FIG. 5 shows a possible behaviour of a Defragmenter-thread (203). Defragmenter (203) receives all files that may have been fragmented through Reallocating(file)-events (206) (signalled by the Filter component (207)). The files are registered in a table internally of the Defragmenter component (203), which does not appear from FIG. 5, as the registering of reallocated files is effected in the thread in which the Reallocation(file)-event (206) occured and not in the Defragmenter thread (203). The thread starts in the state “Waiting for reallocations” (501). Here, the thread is inactive. As soon as a Reallocation(file)-event (206) arises, a change to the state “Analysing” (502) is made, where the files in the internal table are examined for fragmentation one by one until all files have been examined. The analysis implies I/O as the process requires that the file system driver reads from the allocating table. A change to “Analysis interrupted”-state (505) is therefore made when a Prohibit-I/O-event (213) occurs (signalled by I/O-Synchronisator component (202)). An Allow-I/O-event (212) (signalled by I/O-Synchronisator component (202)) causes the analysis to be resumed. When all reallocated files have been analysed for fragmentation (506), a change to the Defragmenting state (503) is made, where all files that have appeared to be fragmented are defragmented. Again, the Prohibit-I/O-signalerne (213) and Allow-I/O-signals (212) provide for that no interference with external I/O requests occurs by changing to the state Defragmentation interrupted (504) when the disk is active. When all files have been defragmented, a change to state “Analysing” (502) is made if new reallocated files (507) have been detected in the meantime. Otherwise, the process returns to the state “Waiting for reallocations” (501).

Besides providing an example of a possible implementation of the invention, the example also demonstrates how the invention can be implemented by only filtering I/O requests to and not from the file system driver (105). Another realisation of the invention may also use filtrated I/O request results the opposite way from the file system driver (105) to the core part system (103). Filter (201) may thereby also signal “Disk-I/O-end” (205) and Reallocated(file)-events (207). With an algorithm corresponding to the one illustrated in FIG. 3.

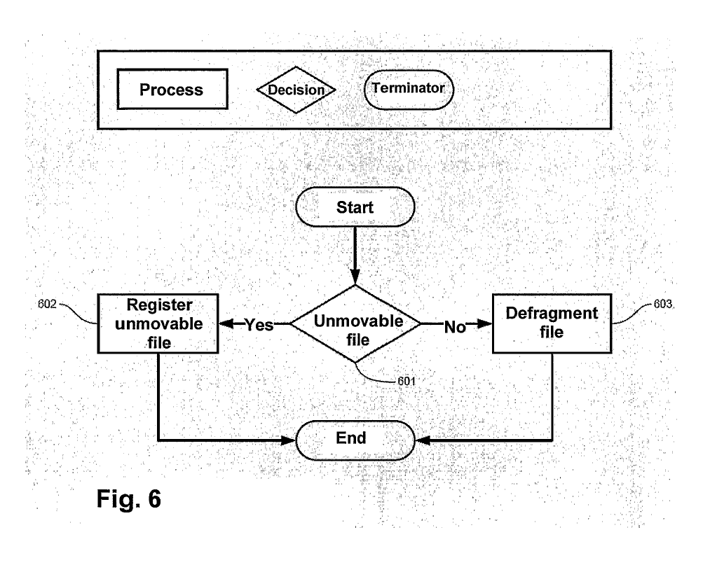

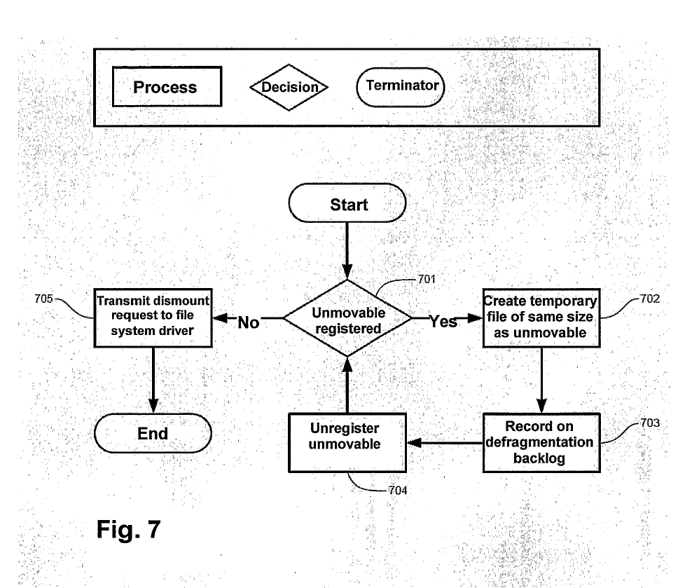

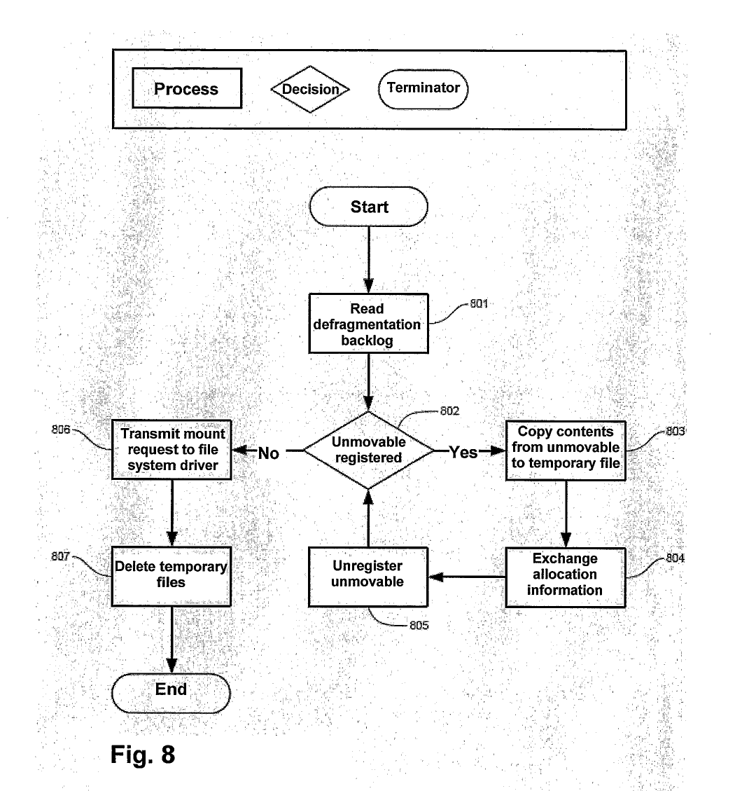

The next example demonstrates how fragmented system files which are normally locked by the file system driver (105) may be defragmented, as a volume is mounted on the system before the file system driver (105) connects to the volume. This example may very well be combined with the first example in the same realisation of the invention. The behaviour is illustrated in the flowcharts in FIGS. 6, 7 and 8 occuring in the Defragmenter component (203). FIG. 6 concerns registration of unmovable files. FIG. 7 concerns establishing a backlog of defragmentation tasks in connection with the next mount. FIG. 8 concerns defragmentation of fragmented files in the backlog in connection with a mount.

The behaviour in FIG. 6 occurs for every defragmentation of a fragmented file. This could e.g. be in the “Defragmenting” state (503) in FIG. 5. If the fragmented file cannot be moved, the file is registered as unmovable (602), otherwise the file (603) is defragmented. The file is registered in a table in the memory.

As a reaction to a dismount event (210), the behaviour occurs as shown in FIG. 7 before the dismount request is transmitted to the file system driver (105). For every file registered as unmovable, a temporary file of the same size as the locked file (702) is created. The temporary file is allocated so that it is not fragmented. Then information about the unmovable and the temporary files is recorded in a defragmentation backlog on the volume (703). The defragmentation backlog is to be retrievable during the next mount by accessing the volume driver (106) directly, i.e. without using the file system driver (105). It may be e.g. to a dedicated sector on the volume or to a certain file, the position of which on the volume the filter driver may derive by itself by reading the allocating table directly. When all unmovable files have been processed, the dismount request is transmitted to the file system driver (705).

FIG. 8 shows what happens when the volume is mounted again and the event “Mounting” (208) is transmitted to “Defragmenter” (203). First, the defragmentation backlog is recorded from (703) in FIG. 7. The contents of every umnovable file is recorded directly from the volume and copied to the corresponding temporary file (803). Then the allocating information is exchanged so that the umovable file points to the sectors of the temporary file, and the temporary file points to the sectors of the umovable file (804). When all umnovable/temporary files have been processed, the mount request is transmitted to the file system driver (806). When the mounting is well completed, all temporary files (807) are deleted. I.e. the sectors used by the fragmented unmovable files are now released again.

The condition for the actual operation of this method for defragmentation of system files is that Defragmenter (203) has a certain knowledge of the filtered file system as Defragmenter (203) is to access the allocation table directly and has to act by itself as a file system driver for a short period of time. However, it is sufficient if it is capable of finding the allocation information for a file and exchange it with another. It is not required to know the form itself of the allocation table in details.

Alternatively, if the system files and the format of the file system and the allocation table is completely known, the behaviour in FIGS. 6 and 7 may be skipped and Defragmenter (203) may by itself do all the work of analysing and defragmenting system files in connection with the mount event (208).

The last example shows how a filter driver may prevent system files from being fragmented. As opposed to the previous example, this happens in a running system while the file system driver is coupled to the volume.

FIG. 9 shows the behaviour occuring in Filter (201) in connection with incoming I/O requests that have to be transmitted to the file system driver. The flowchart in FIG. 9 is an extension of the flowchart in FIG. 3. In fact, the behaviour of the filter component (201) in the first example embodiment may be substituted with the behaviour shown in FIG. 9 and thereby add defragmentation of system files to the first example embodiment.

FIG. 9 appears as FIG. 3 until after Reallocating(file) (206). After that it is checked whether the I/O request comes from an unmovable system file (904), whether the I/O request will let the file increase its size (905), and whether the adjoining sectors are in use (906). If they all can be verified, the adjoining sectors are released by moving them to another place on the volume (907).

There are a number of conditions to be fulfilled before this embodiment example can be performed with success. The filter driver is to know in advance which system files that cannot be moved, the adjoining sectors have to be occupied by movable files, and finally the allocation of the unmovable system files is only to change when the files grow.

1. A system for file defragmenting of file systems in which the storage space on digital storage media (disks) is divided into sectors each constituting a fragment of file data, whereby the sectors of the individual files are moved so that each file will occupy a contiguous array of sectors, and where file system drivers in control of the file systems receive I/O request from user applications;
said system comprising a filter layered above the file system driver, arranged to intercepts I/O to the file system driver and upon interception of that may cause or has caused fragmentation of a file, causes one or more threads to analyze the file for fragmentation, and then defragment it, if fragmented.

2. A system according to claim 1 wherein said filter is arranged to, upon interception of I/O that may cause or has caused I/O to the underlying disk of the file system, cause a message to be sent requesting said threads to temporarily suspend work involving I/O requests to the file system driver.

3. A system according to claim 1 in which the disks are divided into volumes controlled by volume drivers receiving I/O requests from the file system drivers, and wherein each volume driver is fully up and running before a mount I/O request causes a file system driver to mount it;
wherein said filter is arranged to intercepts and holds back a mount I/O request while defragmenting files by sending I/O requests directly to the volume driver, where after the mount I/O request is passed on to the file system driver.

4. A system according to claim 1 in which the disks are divided into volumes controlled by volume drivers receiving I/O requests from the file system drivers, and wherein a dismount I/O request causes a file system driver mounted on a volume driver to dismount from the volume driver;
wherein said filter is arranged to intercepts and holds back a completed dismount I/O request while defragmenting files by sending I/O requests directly to the volume driver, where after the result of the dismount I/O request is returned to the sender of the request.

5. A system according to claim 1 wherein said filter is arranged to, upon interception of an I/O request that will make a file grow when there are not a sufficient number of free adjoining sectors after the file to grow into, cause the adjoining sectors to be freed by moving their contents to another free space on the disk, before passing the I/O request on to the file system driver.
